(19) United States
(12) Patent Application Publication
(10) Pub. No.: US 2015/0081503 A1
(43) Pub. Date: Mar. 19, 2015

(54) Pricing Range-Based Financial Instruments

(71) Applicant: Chicago Mercantile Exchange Inc., Chicago, IL (US)

(72) Inventors: John Labuszewski, Westmont, IL (US); John Nyhoff, Darien, IL (US); John Kerpel, Chicago, IL (US); Lori Aldinger, Naperville, IL (US); Richard Co, Chicago, IL (US)

(73) Assignee: Chicago Mercantile Exchange Inc., Chicago, IL (US)

(21) Appl. No.: 14/031,607

(22) Filed: Sep. 19, 2013

(51) Int. Cl. G06Q 40/04

(52) U.S. Cl. CPC G06Q 40/04
USPC 705/37

(57) ABSTRACT

A method for computing a settlement price of a financial instrument includes: (a) sampling a plurality of high-low range in a market over a period of time; (b) calculating an average of the plurality of high-low range obtained by the sampling; and (c) computing the settlement price of the financial instrument based on the average of the plurality of high-low ranges obtained by the calculating. Systems for computing a settlement price of a financial instrument are described

### BACKGROUND

Financial instruments are tradeable assets that may be broadly classified into two groups: cash instruments (e.g., securities, loans, deposits, etc.) and derivatives. A derivative is a type of financial instrument that derives its value from the value of an underlying entity, such as a physical commodity (e.g., agricultural products, mined resources, etc.) or another financial instrument (e.g., stocks, bonds, currencies, interest rates, financial indices, etc.). Derivatives may be broadly classified into two groups: (1) exchange-traded derivatives (e.g., futures, options on futures, etc.), which are traded on a futures exchange (Exchange); and (2) over-the-counter (OTC) derivatives (e.g., forwards, swaps, etc.), which are bilateral contracts privately traded between two parties without supervision from an Exchange.

The Chicago Mercantile Exchange Inc. (CME) is one example of an Exchange, which provides a contract market where financial instruments, such as futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time. By way of example, an interest rate futures contract, also referred to as an interest rate futures, is a futures contract having an underlying instrument/asset that pays interest, for which the parties to the contract are a buyer and a seller agreeing to the future delivery of the interest-bearing asset, or a contractually-specified substitute. Such a futures contract permits a buyer and seller to lock in the price, or in more general terms, the interest rate exposure, of the interest-bearing asset for a future date.

In contrast to a futures contract, an option is the right, but not the obligation, to sell or buy the underlying instrument (e.g., a futures contract) at a specified price within a specified time. The commodity to be delivered in fulfillment of the contract or, alternatively, the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement (e.g., cash settlement, physical sale and purchase of the underlying reference commodity, etc.).

In the case of exchange-traded derivatives, an Exchange typically provides for a centralized “Clearing House” through which all trades made are confirmed, matched, and settled each day until offset or delivered. The Clearing House is an adjunct to the Exchange, and may be an operating division of the Exchange, which is responsible for settling trading accounts, clearing trades, collecting and maintaining performance bond funds (vide infra), regulating delivery, and reporting trading data. Clearing is the procedure through which the Clearing House becomes buyer to each seller of a futures contract and seller to each buyer (also known as novation), and assumes responsibility for protecting buyers and sellers from financial loss due to breach of contract by assuring performance on each contract. A Clearing Member is a firm qualified to clear trades through the Clearing House. The Clearing Member carries and guarantees the accounts of individual members, clearing firms, and non-member customers doing business through the Exchange to the Clearing House.

As an intermediary, the Exchange bears a certain amount of risk in each transaction that takes place. To that end, risk management mechanisms protect the Exchange via the Clearing House. Indeed, a key role of the Clearing House is the mitigation of credit risk. For example, the Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a Clearing Member, or by a Clearing Member with the Clearing House for the purpose of insuring the broker or Clearing House against loss on open futures or options contracts. This is not a partial payment on a purchase. Rather, the performance bond helps to ensure the financial integrity of brokers, Clearing Members, and the Exchange as a whole. The performance bond to the Clearing House refers to the minimum dollar deposit that is required by the Clearing House from Clearing Members in accordance with their positions. Maintenance, or maintenance margin, refers to a sum, usually smaller than the initial performance bond, which must remain on deposit in the customer's account for any position at all times. A drop in funds below the maintenance margin level (e.g., due to adverse price action) may require a deposit to restore the initial margin level (e.g., a performance bond call). A performance bond call, also referred to as a margin call, is a demand for additional funds to bring the customer's account back up to the initial performance bond level whenever adverse price movements cause the account to go below the maintenance margin level.

While exchange-traded derivatives are structured with standard terms such as contract size, maturity, expiration date, etc. set by an Exchange such as the CME and cleared via the Clearing House for settlement, OTC derivatives, by contrast, are more flexible because, often, none of the business terms of an OTC derivative are standardized. In addition, trades of OTC derivatives, historically, were settled directly through the trading parties since third party Clearing Houses had, on an historical basis, not provided clearing services in the context of OTC derivatives. However, some standardized OTC derivatives may now be cleared through a variety of third-party Clearing Houses. By contrast to exchange-traded derivatives, privately traded OTC derivatives may be associated with higher counterparty risk since the above-described risk management mechanisms implemented by the Exchange may not be in place. Notwithstanding, the OTC derivative market is robust—particularly vis-à-vis certain financial instruments, such as swaps and forwards, and in certain classes of assets, such as interest rates, foreign currencies, equities, and commodities.

OTC derivatives can include swaps, options, caps, floors, corridors, etc. derived from interest rates, foreign currencies, equities and other commodities or financial instruments. By way of example, a representative OTC derivative that may be traded between parties is an interest rate swap (IRS). An IRS is a contractual agreement between two parties (i.e., the counterparties), where one stream of future interest payments is exchanged for another (e.g., a stream of fixed interest rate payments in exchange for a stream of floating interest rate payments, based on a specified principal amount). An IRS may be used to limit or manage exposure to fluctuations in interest rates. Another example of an OTC derivative is an interest rate swap forward contract. An IRS futures contract is a futures in which the underlying instrument is an interest rate swap. As such, an interest rate swap futures contract permits “synthetic” exposure to the underlying interest rate swap (e.g., without entailing actual ownership of the underlying IRS).

To create a new exchange-traded or OTC product—for example, a new type of futures contract for a particular underlying asset—a determination is needed regarding how to value the underlying asset for the purpose of settlement. Additionally, determinations are needed regarding when to list the new contract or otherwise offer it for trading, and how long the contract should trade for before expiring and settling. The creation, trading, and settlement of contracts that require physical delivery of the underlying asset are relatively straightforward assuming that an adequate supply of the underlying asset is available for physical delivery when required. However, if the underlying asset is relatively easy to value but difficult to physically deliver, such as where the underlying asset is an index or portion thereof, delivery may be specified as cash settlement.

With respect to cash-settled contracts, the requisite exchange of value—at settlement or otherwise upon expiration of the contract—is facilitated (e.g., via an Exchange) by computing the value of the positions held by the parties with respect to the market value of the underlying asset.

### BRIEF DESCRIPTION OF THE DRAWINGS

FIG. 1 shows a block diagram of a representative system 100 for computing a settlement price of a financial instrument in accordance with the present teachings.

FIG. 2 shows a flow chart of a representative process 200 for computing a settlement price of a financial instrument in accordance with the present teachings.

FIG. 3 shows a representative general computer system 300 for use with a system in accordance with the present teachings.

### DETAILED DESCRIPTION

Financial instruments (e.g., derivatives including but not limited to futures contracts, options, exchange-traded funds, and the like), which are cash-settled to an index that references an average of high-low ranges (e.g., high-low price ranges) in a particular market sampled over a period of time, have been discovered and are described herein. The high-low price ranges (e.g., realized and/or historical) represent a measure of marketplace volatility that—unlike products based upon or expressed in a variance or standard deviation—does not suffer from an exponential bias (e.g., wherein outsized observations are accorded exponentially greater significance than lesser observations). In some embodiments, the average of the high-low ranges may be directly referenced as the final settlement price of a financial instrument (e.g., the calculated average high-low price range is set as the final settlement price). In some embodiments, the average of the high-low ranges may be indirectly referenced in determining the final settlement price of a financial instrument (e.g., a value mathematically derived from the calculated average high-low price range is set as the final settlement price). In some embodiments, methods are provided for constructing and trading a futures contract that is cash-settled to an index referencing the average (e.g., whether calculated as an arithmetic or geometric mean or as a median) of the high-low ranges in a particular market sampled over a period of time (e.g., a week, a month, etc.).

The reference to average high-low price ranges associated with financial instruments in accordance with the present teachings is qualitatively different than references to average close-to-close price movements (e.g., such as described in U.S. Pat. No. 7,328,184 B1) or day-to-day price movements because, for example, such references, which only look at the price at the start and end of the particular period, fail to account for intra-period (close/day) volatility. By way of example, it is quite possible that the market could be very volatile over the course of a single day, such that the high-low range during that day is particularly wide, and yet that the close-to-close price movement on that day be recorded as nearly zero. In other words, the market may be very volatile and yet still close near the previous day's level. Conventional measures of volatility that reference close-to-close price movements fail to account for such intra-day volatility.

In some embodiments, financial instruments in accordance with the present teachings may be thought of as a form of volatility product. Various designs for volatility products have been proposed as the basis for futures contracts. Previous designs include the Chicago Board Options Exchange (CBOE) S&P 500 Volatility Index (VIX) futures contract, a CBOE futures contract based on the realized or historical variance of close-to-close returns in the spot S&P 500 Index, and various CME Group futures that are cash-settled to the realized or historical standard deviation of close-to-close price movements. It is standard practice when using mathematical option pricing models to input volatility (e.g., one of the key determinants of an option premium) in terms of a standard deviation of the day-to-day percentage change in closing prices (e.g., in terms of the daily returns of the underlying asset). Thus, conventional volatility products are typically based upon or expressed in a variance or standard deviation which, as further described below, may be associated with exponential bias. Moreover, whereas measures of volatility such as standard deviation and variance reference the day-to-day change in final settlement prices, the high-low ranges referenced in accordance with the present teachings are based upon the highs and lows and not on the final settlement prices.

The Chicago Board Options Exchange (CBOE) S&P 500 Volatility Index (VIX) futures contract is cash settled to an index of implied volatilities sampled from various S&P 500 options traded on CBOE. An implied volatility may be thought of as the volatility implicit in the level of an option price or premium, with option premiums generally rising to reflect higher anticipated volatility in the marketplace and generally declining to reflect reduced anticipated volatility in the marketplace. Implied volatilities are typically expressed as a standard deviation of day-to-day or close-to-close returns in the underlying market upon which the option is based.

The formula for a sample standard deviation of a set of data may be expressed as in the following equation:

$$Standard Deviation = 100 * \sqrt{( \frac{252}{N} ) {\sum }_{t = 1}^{N} {( ln \frac{{P}_{t}}{{P}_{t - 1}} )}^{2}}$$

In this equation, N represents the number of elements in a sample, and Pₜ represents a price at time t. Significantly, each return is squared

$$[ i . e . , {( ln \frac{{P}_{t}}{{P}_{t - 1}} )}^{2} ] .$$

As such, the formula explicitly weights each observation on an exponential basis and attributes exponentially more weight to larger (as opposed to smaller) observations of day-to-day returns. Such bias is exaggerated in the context of variance quotations, and the variance of a sampled data set may be thought of as the standard deviation squared. This reliance upon exponential factors may impart an unwarranted bias in the resulting figure.

Throughout this description and in the appended claims, the following definitions are to be understood:

The phrase “coupled with” is defined to mean directly connected to or indirectly connected through one or more intermediate components. Such intermediate components may include both hardware and software based components.

As used in the pending claims and to hereby provide notice to the public, the phrases “at least one of <A>, <B>, . . . and <N>” or “at least one of <A>, <B>, . . . <N>, or combinations thereof” are defined in the broadest sense, superseding any other implied definitions herebefore or hereinafter unless expressly asserted to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While some embodiments described herein may make reference to the CME, it is to be understood that the present teachings are in no way restricted to the CME or, for that matter, to any specific Exchange. On the contrary, the present teachings are applicable to any Exchange, including but not limited to ones that trade in equities and/or other securities.

It is to be understood that elements and features of the various representative embodiments described below may be combined in different ways to produce new embodiments that likewise fall within the scope of the present teachings.

By way of general introduction, a method for computing a settlement price of a financial instrument in accordance with the present teachings comprises: (a) sampling a plurality of high-low ranges in a market over a period of time; (b) calculating an average of the plurality of high-low ranges obtained by the sampling; and (c) computing the settlement price of the financial instrument based on the average of the plurality of high-low ranges obtained by the calculating.

In some embodiments, a method for computing a settlement price of a financial instrument in accordance with the present teachings is implemented using a computer and, in some embodiments, one or a plurality of the acts of (a) sampling, (b) calculating, and/or (c) computing described above are performed by one or a plurality of processors. Determining final settlement prices based on high-lows ranges is a simple and computationally efficient mechanism—especially as compared to referencing an index of implied volatilities, such as the VIX. The simplicity and computational efficiency of basing final settlement prices on high-low ranges may reduce a computer's computational requirements, thereby enabling the computer to do more in less time, utilize fewer resources, and/or minimize consumption of communications bandwidth. By comparison, the VIX methodology is quite complex in that it requires the use of iterative methods to calculate multiple implied volatilities across an ever-shifting sample of options.

The period of time over which high-low ranges in a market are sampled is not restricted, and all manner of time periods are contemplated for use in accordance with the present teachings. In some embodiments, high-low ranges may be sampled over the course of a day and, in other embodiments, over the course of alternate periods (e.g., 1-hour, 15-minute, 30-minute, etc.). By way of example, in some embodiments, the period of time comprises less than a day (e.g., a certain number of minutes, a certain number of hours, or the like), in some embodiments a day, in some embodiments a week, in some embodiments a month, in some embodiments a plurality of months (e.g., 3 months, 6, months, 12 months, and the like), in some embodiments an interval in which trading is allowed (e.g., from a start of a market to a close of the market), in some embodiments an interval in which trading is not allowed, and/or combinations thereof.

In some embodiments, the high-low ranges comprise price ranges. In some embodiments, each of the plurality of high-low ranges sampled over the period of time comprises a daily high-low range (e.g., a daily high-low price range), such that the average of the plurality of high-low ranges comprises an average of daily high-low ranges. In some embodiments, the high-low range for a particular trading session may be identified as a difference between the highest transacted price and the lowest transacted price. In other embodiments, the high-low range may be identified as a difference between the highest observed bid and the lowest observed offer or asking price.

In some embodiments, the financial instrument in accordance with the present teachings comprises a derivative. In some embodiments, the financial instrument comprises an exchange-traded product (e.g., a futures contract, an option on a futures contract, a physical commodity, etc.) and, in some embodiments, an exchange-traded futures contract. In other embodiments, the financial instrument comprises an over-the-counter-traded product (e.g., a swap, an option, a cap, a floor, a corridor, etc., derived from interest rates, foreign currencies, equities, commodities, financial instruments, and/or the like) and, in some embodiments, an over-the-counter-traded forward contract. In still other embodiments, the financial instrument comprises a combination of an exchange-traded product and an over-the-counter-traded product. In some embodiments, the financial instrument comprises a volatility product.

All manner of financial instruments, the settlement price of which may be referenced to the average of high-low ranges, are contemplated for use in accordance with the present teachings. By way of example, in some embodiments, the financial instrument comprises a futures contract on an index that references the average of high-low ranges in a particular market over a period of time (i.e., a futures contract having an underlier that comprises an index that references the average of high-low ranges in a particular market over a period of time). In some embodiments, the financial instrument comprises an option on a futures contract on an index that references the average of high-low ranges in a particular market over a period of time. In some embodiments, the financial instrument comprises an option on an index that references the average of high-low ranges in a particular market over a period of time. In some embodiments, the financial instrument comprises an exchange-traded fund (ETF) based on an index that references the average of high-low ranges in a particular market over a period of time. In some embodiments, the financial instrument comprises a futures contract for an ETF based on an index that references the average of high-low ranges in a particular market over a period of time. In some embodiments, the financial instrument comprises an option on an ETF based on an index that references the average of high-low ranges in a particular market over a period of time.

The average of the high-low ranges calculated in accordance with the present teachings may be correlated, directly or indirectly, with the final settlement price of a financial instrument. In some embodiments, the calculated average high-low price range is set as the final settlement price of a financial instrument (e.g., direct correlation). In other embodiments, a value mathematically derived from the calculated average high-low price range is set as the final settlement price of a financial instrument (e.g., indirect correlation). As a representative and non-limiting example of a direct correlation, the settlement price of a financial instrument (e.g., a futures contract) may be the same as the calculated average high-low price range. As a representative and non-limiting example of an indirect correlation, the settlement price of a financial instrument (e.g., an option on a futures contract) may be mathematically derived (e.g., proportionally or non-proportionally, linearly or non-linearly, exponentially, incrementally or continuously, or the like, or combinations thereof) from the calculated average high-low price range. As a representative and non-limiting example of mathematical derivation, the settlement price of an option on a futures contract may be mathematically derived from the calculated average high-low price range by computing the difference between the strike price of the options and the final settlement price of the underling futures contract (unless this difference is negative, in which case the settlement price is deemed to be zero).

In some embodiments, the financial instrument is configured for final settlement on a delivery date on which the financial instrument expires and/or on a subsequent date fixed in relation to the delivery date. By way of example, in some embodiments, the subsequent date may correspond to a set number of days (e.g., thirty) prior to a given day (e.g., the third Friday) of the calendar month immediately following the month in which the financial instrument expired or, in some embodiments, to the first business day preceding or following this date.

In some embodiments, a financial instrument in accordance with the present teachings is further configured for daily and/or periodic settlement prior to the final settlement. By way of example, daily or other periodic settlement of the financial instrument prior to its final settlement may occur as part of a marking-to-market mechanism (e.g., determining the need for a margin call and, if a margin call is deemed warranted, the amount of the margin call). Such daily and/or periodic settlement of the financial instrument may be accomplished in a manner analogous to final settlement and in accordance with the present teachings.

In some embodiments, the market comprises a financial market which, in some embodiments, comprises a futures market. In some embodiments, the futures market is selected from the group consisting of interest rate futures, interest rate swap futures, currency futures, and combinations thereof. In some embodiments, the futures market comprises CME Group EUR/USD currency futures. In some embodiments, the high-low range in CME Group EUR/USD currency futures may be sampled over a period of time (e.g., the course of a month, etc.) and, subsequently, the average of these high-low ranges may be calculated and referenced as the final settlement price for a financial instrument (e.g., a futures contract). In some embodiments, the average of open, high, low, and/or close prices may be referenced as the final settlement price for a financial instrument.

It is to be understood that all manner of averages and methods for their calculation are contemplated for use in accordance with the present teachings, including but not limited to arithmetic means, geometric means, medians, geometric medians, mode geometric means, harmonic means, quadratic means, generalized means, weighted means, truncated means, interquartile means, midranges, Winsorized means, annualization, and the like, and combinations thereof. In some embodiments, the average of high-low ranges in a particular market over a period of time in accordance with the present teachings is computed as a mean. In some embodiments, the average of high-low ranges in a particular market over a period of time in accordance with the present teachings is computed as a median.

In some embodiments, as described above, the present teachings provide methods for computing a settlement price of a financial instrument. In other embodiments, as further described below, the present teachings also provide systems for computing a settlement price of a financial instrument.

By way of example, a first system for computing a settlement price of a financial instrument in accordance with the present teachings comprises a processor coupled to a non-transitory memory, wherein the processor is operative to execute computer program instructions to cause the processor to: (a) sample a plurality of high-low ranges in a market over a period of time; (b) calculate an average of the plurality of high-low ranges obtained by the sampling; and (c) compute the settlement price of the financial instrument based on the average of the plurality of high-low ranges obtained by the calculating.

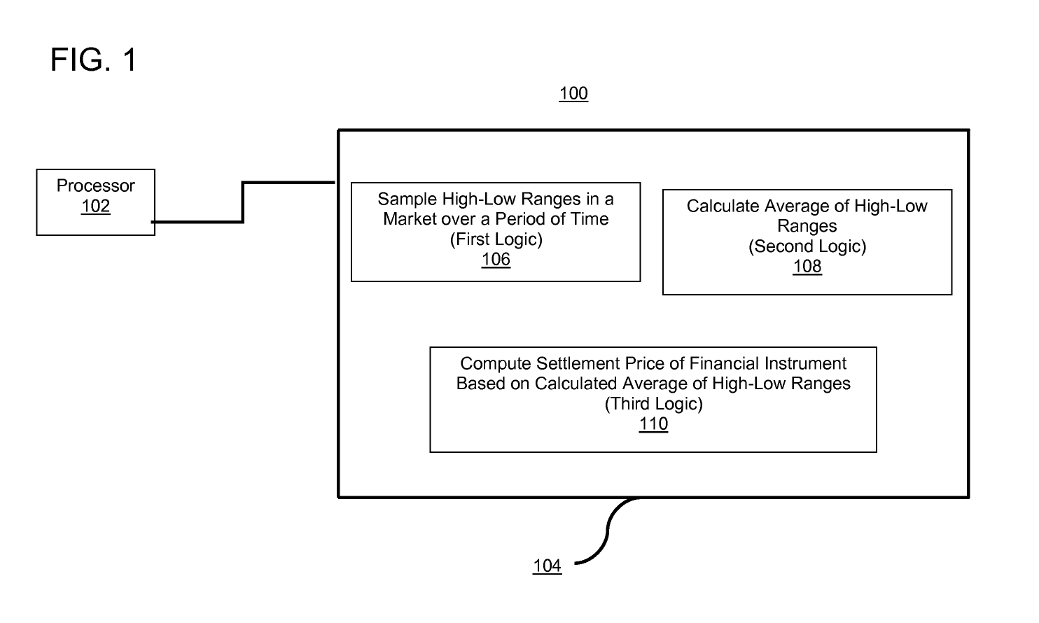

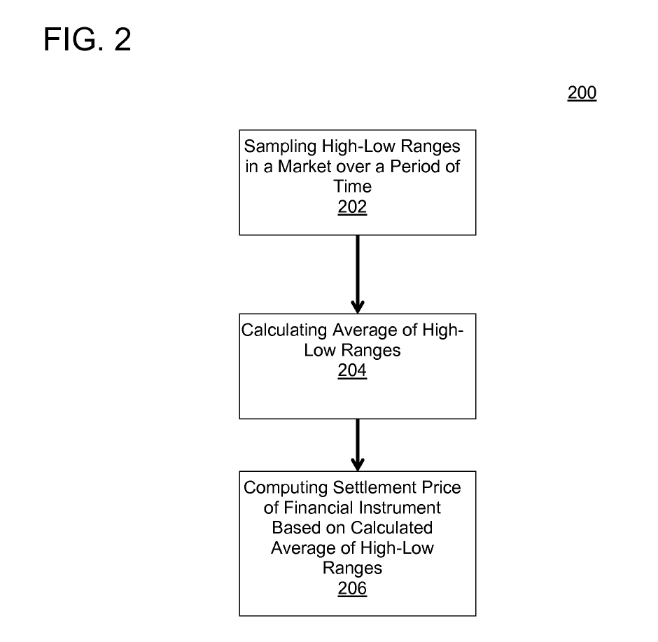

Further aspects of the present teachings will now be described in reference to the drawings. FIG. 1 shows a block diagram of a representative system 100 for computing a settlement price of a financial instrument in accordance with the present teachings. FIG. 2 depicts a flow chart showing exemplary operation of the representative system for computing a settlement price of a financial instrument shown in FIG. 1.

In some embodiments, as shown in FIG. 1, a system 100 for computing a settlement price of a financial instrument in accordance with the present teachings is implemented as part of a settlement price computation module in a computer system. As shown in FIG. 1, the system 100 comprises: a processor 102; a non-transitory memory 104 coupled with the processor 102; first logic 106 stored in the non-transitory memory 104 and executable by the processor 102 to cause the processor 102 to sample a plurality of high-low ranges in a market over a period of time; second logic 108 stored in the non-transitory memory 104 and executable by the processor 102 to cause the processor 102 to calculate an average of the plurality of high-low ranges obtained by the sampling; and third logic 110 stored in the non-transitory memory 104 and executable by the processor 102 to cause the processor 102 to compute the settlement price of the financial instrument based on the average of the plurality of high-low ranges obtained by the calculating.

In some embodiments, the system 100 may be coupled to other modules of a computer system and/or to databases so as to have access to relevant information as needed (e.g., historical high-low price ranges, etc.) and initiate appropriate actions.

FIG. 2 depicts a flow chart showing exemplary operation of the system 100 of FIG. 1. In particular, FIG. 2 shows a computer-implemented method 200 for computing a settlement price of a financial instrument in accordance with the present teachings that comprises: (a) sampling 202, by a processor, a plurality of high-low ranges in a market over a period of time; (b) calculating 204, by the processor, an average of the plurality of high-low ranges obtained by the sampling; and (c) computing 206, by the processor, the settlement price of the financial instrument based on the average of the plurality of high-low ranges obtained by the calculating.

It is to be understood that the relative ordering of some acts shown in the flow chart of FIG. 2 is meant to be merely representative rather than limiting, and that alternative sequences may be followed. Moreover, it is likewise to be understood that additional, different, or fewer acts may be provided, and that two or more of these acts may occur sequentially, substantially contemporaneously, and/or in alternative orders.

A third system for computing a settlement price of a financial instrument comprises: means for sampling a plurality of high-low ranges in a market over a period of time; means for calculating an average of the plurality of high-low ranges obtained by the sampling; and means for computing the settlement price of the financial instrument based on the average of the plurality of high-low ranges obtained by the calculating.

A non-transitory computer-readable storage medium in accordance with the present teachings has stored therein data representing instructions executable by a programmed processor for computing a settlement price of a financial instrument. The storage medium comprises instructions for: (a) sampling a plurality of high-low ranges in a market over a period of time; (b) calculating an average of the plurality of high-low ranges obtained by the sampling; and (c) computing the settlement price of the financial instrument based on the average of the plurality of high-low ranges obtained by the calculating.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an Exchange for financial instruments.

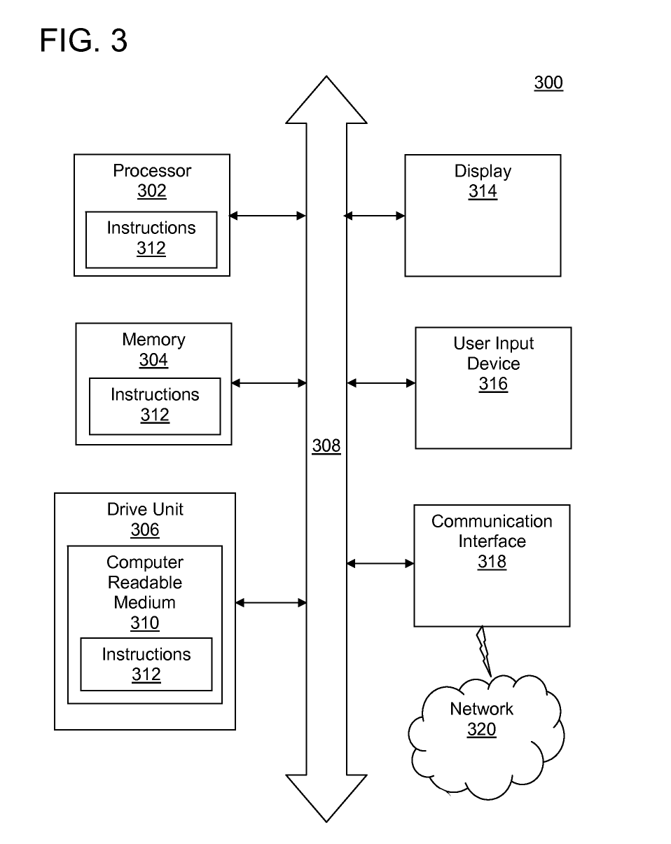

FIG. 3 depicts an illustrative embodiment of a general computer system 300. The computer system 300 can include a set of instructions that can be executed to cause the computer system 300 to perform any one or more of the methods or computer based functions disclosed herein. The computer system 300 may operate as a standalone device or may be connected (e.g., using a network) to other computer systems or peripheral devices. Any of the components discussed above, such as the processor, may be a computer system 300 or a component in the computer system 300. The computer system 300 may implement an order-grouping engine on behalf of an Exchange, such as the Chicago Mercantile Exchange, of which the disclosed embodiments are a component thereof.

In a networked deployment, the computer system 300 may operate in the capacity of a server or as a client user computer in a client-server user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As shown in FIG. 3, the computer system 300 may include a processor 302, for example a central processing unit (CPU), a graphics-processing unit (GPU), or both. The processor 302 may be a component in a variety of systems. For example, the processor 302 may be part of a standard personal computer or a workstation. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The computer system 300 may include a memory 304 that can communicate via a bus 308. The memory 304 may be a main memory, a static memory, or a dynamic memory. The memory 304 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 304 includes a cache or random access memory for the processor 302. In alternative embodiments, the memory 304 is separate from the processor 302, such as a cache memory of a processor, the system memory, or other memory. The memory 304 may be an external storage device or database for storing data. Examples include a hard drive, compact disc (CD), digital video disc (DVD), memory card, memory stick, floppy disc, universal serial bus (USB) memory device, or any other device operative to store data. The memory 304 is operable to store instructions executable by the processor 302. The functions, acts or tasks illustrated in the figures or described herein may be performed by the programmed processor 302 executing the instructions 312 stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 3, the computer system 300 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 302, or specifically as an interface with the software stored in the memory 304 or in the drive unit 306.

Additionally, as shown in FIG. 3, the computer system 300 may include an input device 316 configured to allow a user to interact with any of the components of system 300. The input device 316 may be a number pad, a keyboard, or a cursor control device, such as a mouse, or a joystick, touch screen display, remote control or any other device operative to interact with the system 300.

In some embodiments, as shown in FIG. 3, the computer system 300 may also include a disk or optical drive unit 306. The disk drive unit 306 may include a computer-readable medium 310 in which one or more sets of instructions 312 (e.g., software) can be embedded. Further, the instructions 312 may embody one or more of the methods or logic as described herein. In some embodiments, the instructions 312 may reside completely, or at least partially, within the memory 304 and/or within the processor 302 during execution by the computer system 300. The memory 304 and the processor 302 also may include computer-readable media as described above.

The present teachings contemplate a computer-readable medium that includes instructions 312 or receives and executes instructions 312 responsive to a propagated signal, so that a device connected to a network 320 can communicate voice, video, audio, images or any other data over the network 320. Further, the instructions 312 may be transmitted or received over the network 320 via a communication interface 318. The communication interface 318 may be a part of the processor 302 or may be a separate component. The communication interface 318 may be created in software or may be a physical connection in hardware. The communication interface 318 is configured to connect with a network 320, external media, the display 314, or any other components in system 300, or combinations thereof. The connection with the network 320 may be a physical connection, such as a wired Ethernet connection or may be established wirelessly as discussed below. Likewise, the additional connections with other components of the system 300 may be physical connections or may be established wirelessly.

The network 320 may include wired networks, wireless networks, or combinations thereof. The wireless network may be a cellular telephone network, an 802.11, 802.16, 802.20, or WiMax network. Further, the network 320 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of subject matter described in this specification can be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination thereof).

In some embodiments, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations can include distributed processing, component/object distributed processing, and parallel processing. Alternatively, virtual computer system processing can be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, some embodiments of subject matter described herein can be implemented on a device having a display, for example a CRT (cathode ray tube) or LCD (liquid crystal display) monitor, for displaying information to the user and a keyboard and a pointing device, for example a mouse or a trackball, by which the user can provide input to the computer. Other kinds of devices can be used to provide for interaction with a user as well. By way of example, feedback provided to the user can be any form of sensory feedback (e.g., visual feedback, auditory feedback, or tactile feedback); and input from the user can be received in any form, including but not limited to acoustic, speech, or tactile input.

Embodiments of subject matter described herein can be implemented in a computing system that includes a back-end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include but are not limited to a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A computer-implemented method for computing a settlement price of a financial instrument, the method comprising:
sampling, by a processor, a plurality of high-low ranges in a market over a period of time;
calculating, by the processor, an average of the plurality of high-low ranges obtained by the sampling; and
computing, by the processor, the settlement price of the financial instrument based on the average of the plurality of high-low ranges obtained by the calculating.

2. The computer-implemented method of claim 1 wherein the financial instrument comprises a derivative.

3. The computer-implemented method of claim 1 wherein the financial instrument comprises an exchange-traded product, an over-the-counter-traded product, or a combination thereof.

4. The computer-implemented method of claim 1 wherein the financial instrument comprises a volatility product.

5. The computer-implemented method of claim 1 wherein the financial instrument comprises an exchange-traded futures contract.

6. The computer-implemented method of claim 1 wherein the financial instrument comprises a futures contract on an index referencing the average of the plurality of high-low ranges in the market over the period of time.

7. The computer-implemented method of claim 6, wherein the settlement price of the futures contract on the index is determined to be the average obtained by the calculating.

8. The computer-implemented method of claim 1 wherein the financial instrument comprises an option on a futures contract on an index referencing the average of the plurality of high-low ranges in the market over the period of time.

9. The computer-implemented method of claim 1 wherein the financial instrument comprises an option on an index referencing the average of the plurality of high-low ranges in the market over the period of time.

10. The computer-implemented method of claim 1 wherein the financial instrument comprises an exchange-traded fund (ETF) based on an index referencing the average of the plurality of high-low ranges in the market over the period of time.

11. The computer-implemented method of claim 1 wherein the financial instrument comprises a futures contract for an ETF based on an index referencing the average of the plurality of high-low ranges in the market over the period of time.

12. The computer-implemented method of claim 1 wherein the financial instrument comprises an option on an ETF based on an index referencing the average of the plurality of high-low ranges in the market over the period of time.

13. The computer-implemented method of claim 1 wherein the financial instrument is configured for final settlement on a delivery date on which the financial instrument expires and/or on a subsequent date fixed in relation to the delivery date, and wherein the financial instrument is further configured for daily and/or periodic settlement prior to the final settlement.

14. The computer-implemented method of claim 1 wherein each of the plurality of high-low ranges comprises a daily high-low range.

15. The computer-implemented method of claim 1 wherein each of the plurality of high-low ranges comprises a high-low price range.

16. The computer-implemented method of claim 1 wherein the market comprises a financial market, wherein the financial market comprises a futures market, and wherein the futures market is selected from the group consisting of interest rate futures, interest rate swap futures, currency futures, and combinations thereof.

17. The computer-implemented method of claim 1 wherein the market comprises CME Group EUR/USD currency futures.

18. The computer-implemented method of claim 1 wherein the average is selected from the group consisting of arithmetic means, geometric means, medians, geometric medians, mode geometric means, harmonic means, quadratic means, generalized means, weighted means, truncated means, interquartile means, midranges, Winsorized means, annualization, and combinations thereof.

19. A system for computing a settlement price of a financial instrument, the system comprising:
a processor;
a non-transitory memory coupled with the processor;
first logic stored in the non-transitory memory and executable by the processor to cause the processor to sample a plurality of high-low ranges in a market over a period of time;
second logic stored in the non-transitory memory and executable by the processor to cause the processor to calculate an average of the plurality of high-low ranges obtained by the sampling; and
third logic stored in the non-transitory memory and executable by the processor to cause the processor to compute the settlement price of the financial instrument based on the average of the plurality of high-low ranges obtained by the calculating.

20. The system of claim 19 wherein the financial instrument comprises an exchange-traded product, an over-the-counter-traded product, or a combination thereof.

21. The system of claim 19 wherein the financial instrument comprises a futures contract on an index referencing the average of the plurality of high-low ranges in the market over the period of time.

22. The system of claim 21, wherein the settlement price of the futures contract on the index is determined to be the calculated average.

23. The system of claim 19 wherein the financial instrument comprises an option on a futures contract on an index referencing the average of the plurality of high-low ranges in the market over the period of time.

24. The system of claim 19 wherein the financial instrument comprises an option on an index referencing the average of the plurality of high-low ranges in the market over the period of time.

25. The system of claim 19 wherein the financial instrument comprises an ETF based on an index referencing the average of the plurality of high-low ranges in the market over the period of time.

26. The system of claim 19 wherein the financial instrument comprises a futures contract for an ETF based on an index referencing the average of the plurality of high-low ranges in the market over the period of time.

27. The system of claim 19 wherein the financial instrument comprises an option on an ETF based on an index referencing the average of the plurality of high-low ranges in the market over the period of time.

28. The system of claim 19 wherein the market comprises CME Group EUR/USD currency futures.

29. The system of claim 19 wherein the average is selected from the group consisting of arithmetic means, geometric means, medians, geometric medians, mode geometric means, harmonic means, quadratic means, generalized means, weighted means, truncated means, interquartile means, midranges, Winsorized means, annualization, and combinations thereof.

30. A system for computing a settlement price of a financial instrument, the system comprising:
means for sampling a plurality of high-low ranges in a market over a period of time;
means for calculating an average of the plurality of high-low ranges obtained by the sampling; and
means for computing the settlement price of the financial instrument based on the average of the plurality of high-low ranges obtained by the calculating.

31. In a non-transitory computer-readable storage medium having stored therein data representing instructions executable by a programmed processor for computing a settlement price of a financial instrument, the storage medium comprising instructions for:
sampling a plurality of high-low ranges in a market over a period of time;
calculating an average of the plurality of high-low ranges obtained by the sampling; and
computing the settlement price of the financial instrument based on the average of the plurality of high-low ranges obtained by the calculating.
